(19) United States
(12) Patent Application Publication
(10) Pub. No.: US 2009/0084749 A1
(43) Pub. Date: Apr. 2, 2009

(54) APPARATUS FOR HANDLING PARTS OF ANY KIND, IN PARTICULAR FOR THE LINEAR LOADING AND UNLOADING OF MACHINES

(75) Inventor: Joachim Massmann, Gundelsheim (DE)

Correspondence Address: MOORE & VAN ALLEN PLLC, P.O. BOX 13706, Research Triangle Park, NC, 27709, US

(73) Assignee: FIBRO GMBH, HASSMERSHEIM (DE)

(21) Appl. No.: 12/161,948

(22) PCT Filed: Jan. 18, 2007
(86) PCT No.: PCT/EP2007/000421

§ 371 Date: Jul. 23, 2008

(30) Foreign Application Priority Data
Jan. 23, 2006 (DE) 10 2006 003 321.3
Mar. 27, 2006 (DE) 10 2006 014 408.2

(51) Int. Cl. B23Q 1/60

(52) U.S. Cl. 212/312

(57) ABSTRACT

An apparatus for handling parts of any kind, in particular for the linear loading and unloading of machines, comprising a drive unit (1) for the linear displacement of a beam (2), boom or the like, wherein the beam (2) comprises a guide (3) for a carriage (4), is characterized in that the beam (2) and the carriage (4) can be displaced in the same direction and work in the same direction, and in that the drive unit comprises a stationary drive element (5) and a drive element (6) which is permanently assigned to the beam (2) and which can move with this beam (2), wherein the drive elements (5, 6) act directly or indirectly on one another.

The invention relates to an apparatus for handling parts of any kind, in particular for the linear loading and unloading of machines, with a drive unit for the linear travel of a beam, jib or the like, the beam comprising a guide for a carriage.

Generic apparatuses for handling parts of any kind, in particular for the linear loading and unloading of machines, are known from practice in the most diverse possible versions, specifically with linearly travelable beams and with a carriage moving along the beam. In this respect, reference may be made, merely by way of example, to EP 0 745 453 A2.

In the known apparatuses for handling parts of any kind, in particular for the linear loading and unloading of machines, it is typical that the beam, for example in the form of a jib or the like, is capable of traveling in a predetermined direction. A second movable unit, for example a gripper or the like, can travel, independently of this, along the beam. Further units, such as, for example, even a slide, usually travel at a predetermined angle to the beam, for example orthogonally thereto, to be precise in order, for example, to organize a transfer or handover of any cargo between a longitudinally travelable jib and a gantry beam. Apparatuses of the type in question here are not suitable for purely linear conveyance, these, besides, being complicated in structural terms. Moreover, to ensure sufficient stability, a considerable outlay in structural terms is involved. Finally, a considerable area for carrying out a type of conveyance known from EP 0 745 453 A2 is required.

The object on which the present invention is based, therefore, is to refine and develop an apparatus for handling parts of the generic type, in such a way that, along with the simplest possible design, a linear conveyance of cargo in a very small space is possible.

According to the invention, the above object is achieved by means of the features of patent claim 1. Accordingly, the apparatus, in question here, for handling parts of any kind, in particular for the linear loading and unloading of machines, is characterized in that the beam and the carriage are capable of traveling in the same direction and operate codirectionally.

According to the invention, in the first place, it was recognized that an apparatus of the type in question here is particularly suitable for linear movements or for translational movements when the beam and the carriage can be moved in the manner of telescopic arrangement, to be precise to the effect that the beam and the carriage are capable of traveling in the same direction and correspondingly operate codirectionally. Thus, the apparatus extends in one direction and builds transversely to this direction in an extremely small manner. Moreover, along with sufficiently good stability, a telescopic guide with as short a length as possible can be implemented, to be precise precisely on account of the travel of the beam and carriage in the same direction, to be precise because the beam and the carriage operate codirectionally. The apparatus according to the invention is also suitable ideally for what is known as loading and unloading handling, according to which any cargo, that is to say both workpieces and tools, can be introduced in the shortest possible arrangement into a machine and removed from the machine. The overall apparatus may be assigned to the frame of the machine, such as, for example, a baseplate, or else to an angle part carried by the machine. An apparatus of the type according to the invention may serve, for example, as a shuttle axis for use in any desired machine tool, the tool or workpiece being removed from the machine and delivered, for example, to a belt by means of the apparatus according to the invention.

Furthermore, it may be pointed out, even at this juncture, that the apparatus according to the invention may be arranged horizontally, vertically or at any desired angle to the horizontal. For any desired energy supply, the beam may be equipped with a conventional trailing cable system, to be precise in order to ensure a damage-free follow-up of any supply lines. Any other types of energy supply may be envisaged and can be employed in the claimed apparatus.

Further according to the invention, the drive unit comprises a fixed drive element and a drive element permanently assigned to the beam and movable together with the beam, the drive elements acting directly or indirectly on one another, for example via a gear or via other connection means. In this case, it is of further advantage if the fixed drive element is arranged outside the operating space of the beam, preferably laterally next to it. In other words, the fixed drive element is assigned to the floor, to a machine stand or to another carrier structure. The same applies to the guide of the beam, and this assignment may be identical. By the fixed drive element being arranged laterally with respect to the beam, the latter can have as low a build as possible. The lateral extent of the overall arrangement can likewise be reduced to a minimum dimension.

The drive unit may basically be designed in the manner of a direct drive. Particularly advantageously, however, a fixed toothed belt may be considered as a drive element, with which a drive element permanently assigned to the beam meshes as a movable drive element. Particularly with a view to an especially stable version, the fixed drive element is designed as a rack, with which a drive element permanently assigned to the beam meshes as a movable drive element, and, in a further advantageous way, the latter may be designed as a gearwheel or the like.

For calibration purposes, the fixed drive element, such as, for example, the rack, may be adjustable in its relative position with respect to the beam. It is likewise conceivable that the drive element assigned to the beam is at least slightly adjustable in its position along the beam, specifically likewise for calibration purposes. Adjustment in relation to the fixed drive element, such as, for example, to the rack, is also advantageous. The adjustment of the drive element may take place via an adjusting/calibrating plate which, in turn, can be screwed on or with the beam. Any other possibilities for fastening to the beam may be envisaged.

As already mentioned above, the drive element assigned to the beam may be a rotationally symmetrical drive element, for example a gearwheel which meshes with the rack. It may be noted at this juncture that any coupling means between the machine stand and the travelable beam may be considered, to be precise in order to ensure the linear movement of the beam.

For the drive of the linearly travelable beam, in a further advantageous way, the drive unit comprises a motor permanently assigned to the beam. This may be any type of drive motor, with or without a gear, for example even a torque motor. The drive motor may advantageously be designed as an electric motor. The motor drives, preferably via a gear with step-down or step-up, the drive element which is assigned to the beam and which is supported against the fixed drive element, for example against the rack, and acts against it.

In a further advantageous way, the motor is arranged on that side of the beam which lies opposite the drive element or the drive elements. Correspondingly, the motor is connected, via a shaft extending through the beam, to the drive element assigned to the beam. Such an arrangement is once again conducive to the small type of construction of the overall arrangement.

The motor may serve solely for driving the beam, while the motor may also at the same time drive the carriage on the beam. this will also be discussed later.

As already stated above, the beam is to be understood as being an autonomous conveying device, to be precise as a linear drive independent per se. To move the carriage guided on the beam, particular drive means are provided, and these may comprise a rack, a belt, such as, for example, a V-belt, toothed belt or the like.

Insofar as the drive means are a rack or an arrangement of racks, the rack could preferably be arranged laterally on the carriage. This rack could mesh via a gearwheel with a fixed rack which is assigned in turn to the frame part. Thus, advantageously, a drive would be provided via racks, with a gearwheel being interposed.

Insofar as the drive means comprises a belt, this could be arranged approximately centrally with respect to the beam. The belt would preferably run between two strips of the beam essentially over the entire length of the beam. In this case, the belt may have an endless configuration, the carriage being clamped, screwed or otherwise fastened to the belt. The tensioning of the belt may take place via end-face tensioning devices.

It is likewise conceivable that the belt runs centrally with respect to the beam, between the two strips, essentially over the entire length of the beam, the belt being fastened with free ends to the carriage. Within the scope of such a configuration, the carriage may be assigned tensioning means, via which the belt can be tensioned on the carriage and also released again.

Within the scope of the configuration discussed above, to be precise on the basis of two separate strips which together form the beam, it is further advantageous if each of the strips of the beam carries a guide for the carriage. Correspondingly, it is of further advantage if the carriage is equipped, overall, with four guide blocks, by means of which the carriage runs on or in the guides of the beam. The belt is deflected via end-face rollers between the strips of the beam. Insofar as the tensioning means for the belt are assigned to the beam or to the strips of the beam, it is appropriate to configure the bearings for the rollers or for the bearing-holding blocks in the strips so as to be displaceable or tensionable.

A drive motor permanently assigned to the beam preferably serves as drive means for the carriage, and it may in this case be a drive motor of any type. In particular, electric motors are used here. A pneumatic drive may also basically be envisaged. The motor preferably drives the carriage via a gear, the drive taking place, in particular, via one of the two rollers around which the belt serving for the drive runs.

As also with regard to the drive or motor of the beam, the motor serving as a drive for the carriage is also arranged on that side of the beam which lies opposite the drive elements of the beam. Thus, overall, two different or else identical motors may be provided, to be precise, on the one hand, for driving the beam and, on the other hand, for driving the carriage travelable on the beam.

In a most particularly advantageous way, the beam and the carriage may be driven via the same motor, in such a case the motor which serves for the common drive of the beam and carriage rotating one or two drive shafts which preferably act via a gear in each case on the drive means of the carriage and on the drive means of the beam. A single motor is therefore basically sufficient to implement both the movement of the beam and the movement of the carriage on the beam.

Particularly in the case of a drive by a single motor, it is advantageous if the beam is driven with respect to the fixed drive element via drive wheels and a drive belt acting between them, all the assemblies of the drive, with the exception of the fixed drive element, being carried by the beam. Any other desired coupling possibilities are conceivable and implementable.

It is basically possible, furthermore, that the carriage is designed in the same way as a second beam, so that the beam and the carriage complete one another to form a telescopic guide in the manner of a linearly operating telescopic conveyor. A plurality of beams and carriages may be arranged in the manner of a cascade with respect to one another, so that, overall, a telescopic unit of extremely short or small build and having a plurality of telescopic elements is obtained.

As already mentioned above, the beam is equipped with two guide systems, to be precise, on the one hand, with a guide system for guiding the beam with respect to the floor, a column, etc. and, on the other hand, with a guide system for guiding the carriage on the beam. The two guide systems may be designed identically or differently, depending on requirements and depending on the forces to be absorbed.

Furthermore, it may be noted that the beam, together with the carriage, may operate horizontally, vertically or at a predeterminable angle. Any merely possible arrangement of the apparatus described above may be envisaged.

It may also be mentioned that the carriage may serve for the reception of any parts, such as, for example, for the reception of workpieces, tools and/or other handling appliances. Thus, the apparatus according to the invention can be used for any transfer of parts, in particular for the linear transfer of parts out of a machine tool and into a machine tool.

There are, then, various possibilities for refining and developing the teaching of the present invention in an advantageous way. For this purpose, on the one hand, reference is made to the patent claims subordinate to patent claim 1, and on the other hand, to the following explanation of two exemplary embodiments of the invention by means of the drawing. In conjunction with the explanation of the preferred exemplary embodiments of the invention by means of the drawing, generally preferred refinements and developments of the teaching are also explained. In the drawing:

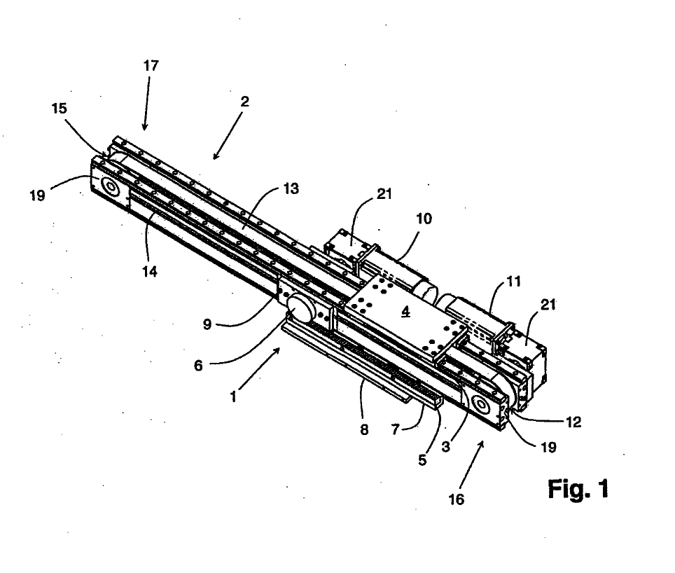

FIG. 1 shows a diagrammatic view of a first exemplary embodiment of an apparatus according to the invention, a motor being provided in each case for driving the beam and the table,

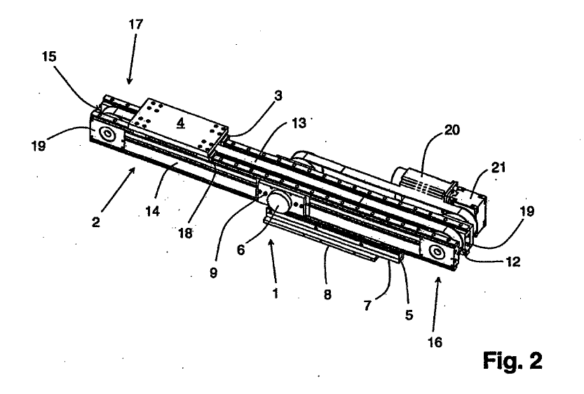

FIG. 2 shows a diagrammatic view of a second exemplary embodiment of an apparatus according to the invention, a single motor being provided for driving the beam and the carriage;

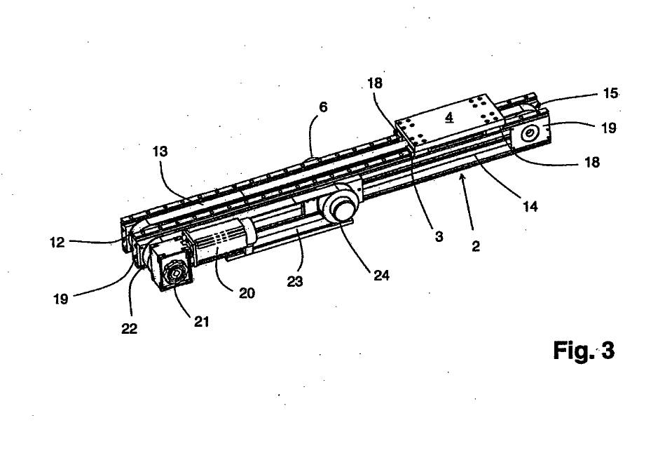

FIG. 3 shows a diagrammatic view of the subject of FIG. 2 in a view from the other side, that is to say as seen from the motor side,

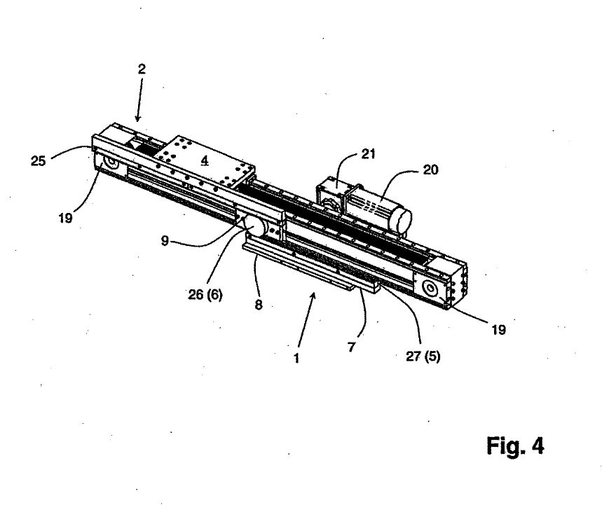

FIG. 4 shows a diagrammatic view of a third exemplary embodiment of an apparatus according to the invention, two racks being provided for driving the carriage, and

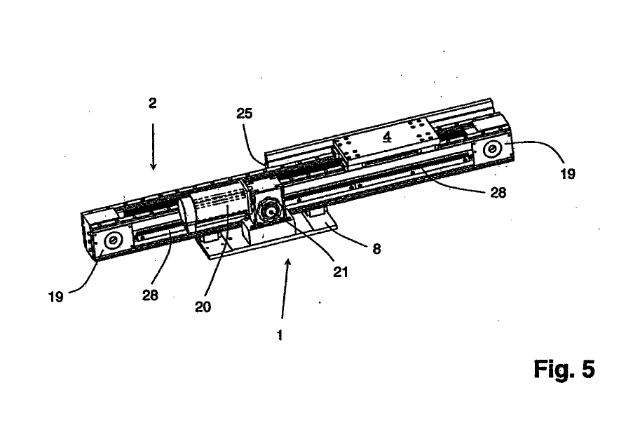

FIG. 5 shows a diagrammatic view of the subject of FIG. 4 in a view from the other side, that is to say as seen from the motor side.

FIGS. 1 to 3 show two different exemplary embodiments of an apparatus according to the invention for handling parts of any kind, in particular for the linear loading and unloading of machines. The apparatus comprises a drive unit 1 for the linear travel of a beam 2, the beam 2 serving for the linear conveyance of any cargo and being capable of independently traveling linearly. The beam 2 may be, for example, a jib.

FIGS. 1, 2 and 3 jointly show that the beam 2 comprises a guide 3 for a carriage 4. According to the invention, the beam 2 and the carriage 4 are capable of traveling in the same direction, that is to say are capable of operating codirectionally.

FIG. 1 shows clearly that the drive unit 1 comprises a fixed drive unit 5 and a drive unit 6 permanently assigned to the beam 2 and movable together with the beam 2, the two drive units 5, 6 acting directly on one another. In the exemplary embodiment shown in FIG. 1, the fixed drive unit 5 is designed as a rack and the movable drive unit 6 has a gearwheel meshing with the rack.

The rack 5 is connected firmly to a frame part 8 of the respective machine via a special receptacle 7. A calibration of the rack 5 is possible via the receptacle 7.

FIG. 1 shows, further, that the gearwheel 6 can be set or calibrated on the beam 2 via an adjusting/calibrating plate 9. The arrangement of the gearwheel 6 is otherwise fixed.

In the exemplary embodiment shown in FIG. 1, overall, two different drives or motors 10, 11 are provided, to be precise a motor 10 for the drive or travel of the beam 2 and a motor 11 for the travel of the carriage 4. The two motors 10, 11 can be activated independently of one another.

FIG. 1 shows, further, that the motors 10, 11 are arranged on the beam 2 on the side facing away from the two drive units 5, 6 and are permanently connected to said beam. While the motor 10 for the beam 2 ends via a shaft, which cannot be seen, through the beam 2 on the movable drive unit 6 or on the gearwheel 6 in this, the gearwheel 6 meshing with the rack 5, the motor 11 for the carriage 4 acts on a drive roller 12 for driving the carriage 4. A belt 13 serving for driving the carriage 4 runs between two strips 14 of the beam 2 both via the drive roller 12 and via an end-face deflecting roller 15, so that the carriage 4 can travel back and forth, as desired, via the belt 13.

FIG. 1 indicates, further, that the beam 2 or the strips 14 of the beam 2 have two different guide systems, to be precise, on the one hand, a lower guide system 16 and, on the other hand, an upper guide system 17. The lower guide system serves for guiding the beam 2 with respect to the frame part 8, while the upper guide system 17 serves for guiding the carriage 4 on the beam 2. Furthermore, the carriage 4 comprises four guide blocks 18 which belong to the upper guide system 17 and via which the carriage 4 can be guided, tilt-free and virtually play-free.

Mention may be made, further, with regard to FIG. 1, that the belt 13 can be tensioned, specifically via the end-face bearing blocks 19 in which the drive roller 12 and the deflecting roller 15 are mounted.

It is likewise possible that, in the case of fixed deflecting rollers 15, the tensioning of the belt 13 takes place directly on the carriage 4.

FIGS. 2 and 3 show, as seen from different sides, a second exemplary embodiment of an apparatus according to the invention, there a single motor 20 serving both for driving the beam 2 and for driving the carriage 4. The rest of the set-up is unchanged in relation to the exemplary embodiment from FIG. 1. The designations of the components are the same.

The common motor 20 according to the exemplary embodiment from FIGS. 2 and 3 acts via a gear 21 both on the drive roller 12 and therefore on the belt 13 for driving the carriage 4 and on a further drive roller 22 which in turn, drives a belt 23, via the belt 23 a deflecting roller 24 and, via a shaft extending through the beam 2, the gearwheel 6 which is arranged on the other side of the beam 2 and which meshes with the fixed rack 5. The gear 21 is preferably a multistep gear, via which the two drive rollers 12, 22 can be moved or rotated independently of one another. Thus, a single drive or motor 20 is sufficient in order to implement both movements, to be precise both the movement of the beam 2 and the movement of the carriage 4 on the beam 2.

FIGS. 4 and 5 show a third exemplary embodiment of an apparatus according to the invention, there a rack 25 being arranged laterally on the carriage 4 for driving the carriage 4. The rack 25 assigned to the carriage 4 cooperates via a gearwheel 26 with a fixed rack 27 which, in turn, is assigned to the frame part 8. Consequently, the carriage 4 is driven via an arrangement of racks 25, 27, with a gearwheel 26 being interposed.

FIG. 5 shows the arrangement from FIG. 4 from the other side, that is to say as seen from the side of the motor 20. There, too, a rack 28 serves for the drive, to be precise for the drive of the entire beam 24 which, again, carries the carriage 4. On account of the arrangement selected here, only a single motor 20 is required, to be precise in order to drive both the beam 2 and the carriage 4.

With regard to features which cannot be gathered from the figures, reference may be made to the general part of the description in order to avoid repetition.

1-33. (canceled)

34. An apparatus for the linear loading and unloading of machines, comprising a beam, a carriage, and a drive unit for the linear travel of said beam, said beam comprising a guide for said carriage, wherein said beam and said carriage are capable of traveling in the same direction and operate codirectionally, and wherein said drive unit comprises a first drive element that is fixed and a second drive element that is dedicated to said beam and movable together with said beam, said first and second drive elements acting directly or indirectly on one another.

35. The apparatus as claimed in claim 34, wherein said first drive element is arranged laterally adjacent to and outside the operating space of said beam.

36. The apparatus as claimed in claim 34, wherein said first drive element comprises a fixed toothed belt with which said second drive element meshes.

37. The apparatus as claimed in claim 34, wherein said first drive element comprises a fixed rack with which said second drive element meshes.

38. The apparatus as claimed in claim 34, wherein said second drive is adjustable in its position along said beam.

39. The apparatus as claimed in claim 34, wherein said second drive element is adjustable in its position on said beam in relation to the fixed drive element.

40. The apparatus as claimed in claim 34, further comprising an adjusting-calibrating plate, wherein the adjustment of said second drive element is accomplished by use of said adjusting-calibrating plate.

41. The apparatus as claimed in claim 34, wherein said second drive element comprises a rotationally symmetrical drive element.

42. The apparatus as claimed in claim 34, wherein said drive unit comprises a motor dedicated to said beam, which drives said second drive element via a gear.

43. The apparatus as claimed in claim 42, wherein said motor is arranged on that side of said beam which lies opposite said second drive element.

44. The apparatus as claimed in claim 43, wherein said motor is connected, via a shaft extending through said beam, to said second drive element.

45. The apparatus as claimed in claim 42, wherein said motor serves solely for driving said beam.

46. The apparatus as claimed in claim 34, wherein said beam comprises a third drive element for the carriage.

47. The apparatus as claimed in claim 46, wherein said third drive element comprises at least one of a rack or a belt.

48. The apparatus as claimed in claim 47, wherein said rack is arranged laterally on said carriage and meshes via a gearwheel with a fixed rack which is assigned to a fixed frame.

49. The apparatus as claimed in claim 47, wherein said beam comprises two strips and wherein said belt runs approximately centrally with respect to said beam, between said two strips over the entire length of said beam, and wherein said carriage is at least one of clamped or screwed to said belt.

50. The apparatus as claimed in claim 47, wherein said beam comprises two strips and wherein said belt runs approximately centrally with respect to said beam, between said two strips over the entire length of said beam, and wherein said carriage is fastened to said belt.

51. The apparatus as claimed in claim 47, wherein said carriage comprises a tensioning element for tensioning said belt.

52. The apparatus as claimed in claim 49, wherein each of said two strips carries a guide for said carriage.

53. The apparatus as claimed in claim 52, wherein said carriage runs by means of four guide blocks on or in said guides.

54. The apparatus as claimed in claim 47, wherein said beam comprises two rollers and wherein said belt is deflected via two rollers on said beam.

55. The apparatus as claimed in claim 46, wherein said beam comprises two rollers and wherein said third drive element comprises a motor dedicated to said beam, which drives said carriage via one of said two rollers.

56. The apparatus as claimed in claim 55, wherein said motor is arranged on that side of said beam which lies opposite said first and second drive elements of said beam.

57. The apparatus as claimed in claim 34, wherein said beam and said carriage are driven via the same motor.

58. The apparatus as claimed in claim 57, wherein said drive unit further comprises at least one drive shaft and at least one gear and wherein said motor serving for the common drive of said beam and said carriage rotates said at least one drive shaft which acts via said at least one gear on said third drive element and on said first and second drive elements.

59. The apparatus as claimed in claim 34, wherein said drive unit comprises at least one drive wheel and at least one drive belt and wherein said beam is driven with respect to said first drive element via said at least one drive wheel with said at least one drive belt acting between them, wherein all assemblies of said drive unit, with the exception of said first drive element, are carried by said beam.

60. The apparatus as claimed in claim 34, wherein said carriage comprises a second beam, so that said second beam and said carriage together form a telescopic guide.

61. The apparatus as claimed in claim 60, further comprising a plurality of beams and carriages arranged in a cascade with respect to one another.

62. The apparatus as claimed in claim 34, wherein said beam comprises first and second guide systems, said first guide system for guiding said beam with respect to the floor, said second guide system for guiding said carriage on said beam.

63. The apparatus as claimed in claim 62, wherein said first and second guide systems are identical.

64. The apparatus as claimed in claim 62, wherein said first and second guide systems are different.

65. The apparatus as claimed in claim 34, wherein said beam, together with said carriage, operate at least one of horizontally, vertically or at a predetermined angle.

66. The apparatus as claimed in claim 34, wherein said carriage is configured to receive the machines.
